(19) United States
(12) Patent Application Publication
(10) Pub. No.: US 2024/0351889 A1
(43) Pub. Date: Oct. 24, 2024

(54) METHOD FOR PRODUCING SILICA PARTICLES, SILICA PARTICLES PRODUCED BY SUCH METHOD, COMPOSITIONS AND USES OF SUCH SILICA PARTICLES

(71) Applicant: MERCK PATENT GMBH, Darmstadt (DE)

(72) Inventors: Eric JACQUINOT, Trosly Breuil (FR); Leo HANUS, Wilmington, DE (US); Geary GRAHAM, Wilmington, DE (US)

(73) Assignee: MERCK PATENT GMBH, Darmstadt (DE)

(21) Appl. No.: 18/684,228

(22) PCT Filed: Aug. 10, 2022
(86) PCT No.: PCT/EP2022/072412

§ 371 Date: Feb. 16, 2024

(30) Foreign Application Priority Data
Aug. 19, 2021 (EP) 21306129.4

(51) Int. Cl. C01B 33/158; C01B 33/141; C01B 33/152

(52) U.S. Cl. CPC C01B 33/158; C01B 33/1415; C01B 33/152; C01P 2006/80

(57) ABSTRACT

The present application relates to a method for producing silica particles, and to the silica particles produced by such method. The present application further relates to compositions comprising the silica particles produced by such method as well as to uses of such silica particles and compositions comprising such silica particles.

### TECHNICAL FIELD

The present application relates to a method for producing silica particles, and to the silica particles produced by such method. The present application further relates to compositions comprising the silica particles produced by such method as well as to uses of such silica particles and compositions comprising such silica particles.

### BACKGROUND

Silica particles may be used in a wide range of applications. They may, for example, be used as abrasives, as additives in paper making and in the paper itself, as catalyst supports, as drug carriers, in coatings or paints, to only name a few.

More and more of these applications require the silica particles to be of high purity, i.e. to contain a low level of contaminants, such as trace metal and/or organic contaminants. This is the case, for example, in catalysts and catalyst supports, where the absence of contaminants can lead to an increase in the yield of the desired product. Due to modern electronic devices, such as semiconductor devices, memory devices, integrated circuits, and the likes becoming smaller and smaller, silica particles used in the manufacturing of such modern electronic devices have to comply with ever increasing purity requirements.

In addition, environmental concerns and political pressure require industry to develop and implement more sustainable products and production processes, which may, for example, be advantageous due to lower energy consumption or reduced waste. Alternatively, a manufacturing process may be rendered more sustainable if such process builds upon a side product or waste product of a different manufacturing process.

In a typical conventional “wet” process for producing silica particles, i.e. a process for producing silica particles essentially performed in aqueous medium, a sodium or potassium orthosilicate (Na₄SiO₄ or K₄SiO₄, or more generally SiO₂·x M₂O with M being Na or K) is subjected to an ion exchange process, resulting in orthosilicic acid (“Si(OH)₄”), which is then polycondensated to form the silica particles (“SiO₂”). This process, however, has the disadvantage of—if not removed by respective purification steps—introducing significant amounts of metal contaminants, such as sodium, into the silica particles.

Alternatively, as for example disclosed in US 2007/0237701 A1, it is known to hydrolyze tetramethoxysilane (TMOS) or tetraethoxysilane (TEOS) to produce orthosilicic acid, which may then be polycondensated to form the silica particles. While this process is capable of producing silica particles having low levels of metal contaminants, the organic residues from the starting materials as well as the need to use organic solvents in the production process, introduce undesired organic contaminants into the silica particles.

As disclosed in US 2012/0145950 A1 a colloidal silica of high purity may be produced by dissolving a fumed silica in an aqueous solvent comprising an alkali metal hydroxide to produce an alkaline silicate, removing the alkali metal via ion exchange to generate a silicic acid solution; and initiating nucleation and particle growth. However, while capable of producing silica particles of high purity, this method has the disadvantage of relying on fumed silica, the production of which already consumes significant amounts of energy, as starting material.

As these examples of different production processes and pathways show, there is a need in the industry for an improved method for producing silica particles.

Thus, the present application aims at providing an improved method for producing silica particles, particularly a method allowing for improved sustainability or high purity or preferably both, improved sustainability and high purity.

### SUMMARY

The present inventors now have surprisingly found that these objects may be attained either individually or in any combination by the present production method.

The present application therefore provides for a method for the production of silica particles, said method comprising the steps of
(a) hydrolyzing a silicon chloride in aqueous solution, thereby producing a gel comprising silicic acid and hydrogen chloride, wherein the silicon chloride is of the following formula (1′)

R_{c}Si(OH)_{d}Cl_{4-c-d} (1′)
with R being at each occurrence independently selected from the group consisting of alkyl groups having 1, 2, or 3 carbon atoms; and c being at each occurrence independently selected from the group consisting of 0, 1, 2, and 3; and d being at each occurrence independently selected from the group consisting of 0, 1, 2, and 3; provided that c+d≤3;
(b) removing at least part of the hydrogen chloride from the gel to obtain a purified gel;
(c) adjusting the pH of the purified gel to at least 9; and
(d) then polycondensating the silicic acid to form the silica particles.

Additionally, the present application provides for silica particles obtained by such method as well as to formulations comprising an aqueous dispersion of such silica particles.

### DETAILED DESCRIPTION

Throughout this application, “Me” is to denote a methyl group (—CH₃), “Et” is to denote an ethyl group (—CH₂—CH₃), “nPr” is to denote a n-propyl group (—CH₂—CH₂—CH₃), and “iPr” is to denote an iso-propyl group (—CH(CH₃)₂).

For the purposes of the present application, the term “silicate” is used to denote salts and esters of ortho-silicic acid (Si(OH)₄), which throughout this application may also be referred to as “silicic acid”, and its condensation products. It is also noted that a gel or a solution of silicic acid is understood to generally also comprise condensates of silicic acid.

For the purposes of the present application, the terms “silica particle” and “silica particles” is/are preferably used to denote colloidal silica particles. The term “colloidal” is used to denote particles dispersed in a medium having at least in one direction a dimension between 1 nm and 1 μm (see also Compendium of Chemical Terminology, Gold Book, International Union of Pure and Applied Chemistry, Version 2.3.3, 2014 Feb. 24, page 295).

Generally stated, the present application relates to a method for the production of silica particles, wherein the method comprises the steps of
(a) hydrolyzing a silicon chloride in aqueous solution, thereby producing a gel comprising silicic acid and hydrogen chloride;
(b) removing at least part of the chloride and-if present-fluoride from the gel to obtain a purified gel;
(c) adjusting the pH of the purified gel; and
(d) then polycondensating the silicic acid to form the silica particles.

The silicon chloride hydrolyzed in step (a) of the present method may be represented by the following formula (1′)

R_{c}Si(OH)_{d}Cl_{4-c-d} (1′)

wherein R, c and d are as defined herein.

R is at each occurrence independently selected from the group consisting of alkyl groups having 1, 2, or 3 carbon atoms. Thus, R may at each occurrence independently be selected from the group consisting of methyl (—CH₃), ethyl (—CH₂—CH₃), n-propyl (—CH₂—CH₂—CH₃), and iso-propyl (—CH(CH₃)₂). Preferably, R is at each occurrence independently methyl or ethyl. Most preferably, R is methyl.

c is at each occurrence independently selected from the group consisting of 0, 1, 2, and 3.

d is at each occurrence independently selected from the group consisting of 0, 1, 2, and 3.

c and d are in any case selected under the provision that c+d≤3.

Thus, for c being 0, d may be selected from the group consisting of 0, 1, 2, and 3; and for c being 1, d may be selected from the group consisting of 0, 1, and 2; and for c being 2, d may either be 0 or 1; and for c being 3, d is 0.

Preferably, the silicon chloride hydrolyzed in step (a) of the present method may be represented by the following formula (1)

RₐSiCl₄₋ₐ (1)

wherein R and a are as defined herein.

a is an integer at each occurrence independently selected from the group consisting of 0, 1, 2, and 3. Preferably, at each occurrence independently, a is 0 or 1. Most preferably a is 0.

Expressed differently, the silicon chloride hydrolyzed in step (a) may preferably be selected from the group consisting of SiCl₄, MeSiCl₃, Me₂SiCl₂, Me₃SiCl, EtSiCl₃, Et₂SiCl₂, Et₃SiCl, nPr₂SiCl₃, nPr₂SiCl₂, nPr₃SiCl, iPrSiCl₃, iPr₂SiCl₂, iPr₃SiCl, and any blend of any of these; more preferably from the group consisting of SiCl₄, MeSiCl₃, Me₂SiCl₂, Me₃SiCl, EtSiCl₃, Et₂SiCl₂, Et₃SiCl, and any blend of any of these; even more preferably from the group consisting of SiCl₄, MeSiCl₃, Me₂SiCl₂, Me₃SiCl, and any blend of any of these; still even more preferably is SiCl₄ or MeSiCl₃, and most preferably is SiCl₄.

The selection of SiCl₄ as starting material for the present process is particularly advantageous as it is a by-product or waste product of silicon wafer production and therefore available in high purity and significant volumes. Alternatively, SiCl₄ may also be obtained from SiO₂ by chlorination in presence of a reducing agent such as carbon.

It is noted that the silicon chloride of step (a) may be a mixture of various different silicon chlorides, for example, a mixture of any one or more silicon chlorides defined above. It is, however, preferred that the silicon chloride comprises only one of these in at least 90 wt %, more preferably in at least 95 wt %, even more preferably in at least 97 wt %, still even more preferably in at least 99.0 wt %, and most preferably in at least 99.5 30 wt %, with wt % relative to the total weight of silicon chloride.

Hydrolysis of the silicon chloride in step (a) is preferably performed at a temperature of at least 0°° C., for example of at least 5° C. or 10° C., more preferably of at least 20° C., even more preferably of at least 30° C., still even more preferably of at least 40° C., and most preferably of at least 50° C.

Hydrolysis of the silicon chloride in step (a) is preferably performed at a temperature of at most 120° C., more preferably of at most 110° C., even more preferably of at most 100° C., and most preferably of at most 90° C. Generally, the hydrolysis of the silicon chloride in step (a) is performed under atmospheric pressure. It is, however, also possible to perform the hydrolysis of the silicon chloride in step (a) at elevated pressure, for example at up to 10 bar, thereby permitting the hydrolysis of the silicon chloride in step (a) to be performed at higher temperatures, for example at up to 150° C.

It is further noted that the hydrolysis of the silicon chloride in step (a) may be accelerated by raising the temperature of the aqueous medium. However, for commercial production this may not be advantageous as it requires significant amounts of energy, thereby rendering the process less sustainable. It also needs to be kept in mind that the hydrolysis of silicon chloride is exothermic, thus leading to a rise in temperature of the aqueous medium, meaning that separate heating may not be required. Furthermore, for further process steps the resulting gel will need to be cooled, thus again requiring energy and/or additional time.

At the start of step (b), the aqueous solution is preferably at a temperature of at least 0° C., more preferably at a temperature of at least 10° C., or equivalently the lowest temperature at which the solution is still a liquid. At the start of step (b), the aqueous solution is preferably at a temperature of at most 50°° C., more preferably of at most 40° C., even more preferably of at most 30° C., and most preferably of at most 20° C. Thus, at the start of step (b), the aqueous solution may be at a temperature preferably in the range from 0°° C. to 50° C., or 0°° C. to 40° C., or 0°° C. to 30°° C., or 0° C. to 20° C.

Preferably, in step (a) the weight ratio of water to silicon chloride, for example to SiCl₄, is at least 5, more preferably at least 6. Preferably said weight ratio of water to silicon chloride, for example to SiCl₄, is at most 20 (for example, at most 19, or at most 18, or at most 17, or at most 16), and most preferably at most 15 (for example, at most 14, or at most 13, or at most 12, or at most 11, or at most 10). Thus, preferably the weight ratio of water to silicon chloride, for example to SiCl₄, may be in the range of from 5 to 20, or in the range of from 6 to 20, and more preferably in the range of from 5 to 15, or in the range of from 6 to 15.

Optionally, to facilitate dissolving the silicic acid produced in step (a) of the present method, a dissolving aid may be added to the aqueous solution. Such dissolving aid may, for example, be hydrogen fluoride (HF).

Without wishing to be bound by theory, it is believed that hydrolysis of the silicon chlorides as defined above, wherein a is selected from the group consisting of 1, 2, and 3, proceeds first via hydrolysis of the chloride, followed by a condensation reaction, thus resulting in a siloxane intermediate as illustrated by the following equations for a=3, the siloxane then being further hydrolyzed to silicic acid:

R₃Si—Cl+H₂O→R₃Si—OH+HCl

R₃Si—OH+R₃Si—Cl→R₃Si—O—SiR₃+HCl

The hydrolysis of the silicon chloride in step (a) produces significant amounts of hydrogen chloride (HCl), of which in the subsequent step (b) of the present process at least part is removed from the gel to obtain a purified gel.

Thus, in step (b) of the present process the total content of both, chloride and-if present, for example, due to the need of using a dissolving aid as defined herein-fluoride, is preferably reduced to at most 40,000 ppm (for example, to at most 30,000 ppm, or to at most 20,000 ppm); more preferably to at most 10,000 ppm (for example, to at most 9,000 ppm, or to at most 8,000 ppm, or to at most 7,000 ppm, or to at most 6,000 ppm, or to at most 5,000 ppm, or to at most 4,000 ppm, or to at most 3,000 ppm, or to at most 2,000 ppm); even more preferably to at most 1,000 ppm (for example, to at most 900 ppm, or to at most 800 ppm, or to at most 700 ppm, or to at most 600 ppm); and most preferably to at most 500 ppm (for example, to at most 400 ppm, or to at most 300 ppm or to at most 200 ppm or to at most 100 ppm), with ppm relative to silica (“SiO₂”). It is noted that the maximum total amount of chloride and—if present—fluoride can be selected on basis of the requirements of the application the so-produced silica particles are to be used in.

The removal of at least part of the chloride and—if present—fluoride from the gel in step (b) of the present process to obtain a purified gel may be done by any suitable method. It is, however, preferred that step (b) comprises the step of (b1) washing the gel with water, i.e. washing the gel by the addition and subsequent removal of water, preferably de-ionized water, more preferably ultra-pure water. Preferably, each washing is done with a volume of water, said volume being preferably of from 50% to 200%, more preferably of from 70% to 150%, and most preferably of from 80% to 120% of the reaction volume the gel was prepared in. The washing water and the gel may be separated again by filtration, or by distilling at least a part of the water off from the gel.

Depending upon the content of chloride and fluoride to be reached, step (b1) may be repeated as often as necessary.

Depending upon the intended application and the respective requirements, e.g. with regards to purity, the total content in chloride and/or—if present—fluoride may be reduced to low content by suitable methods (for example, an anion exchange step, or a micro-or nanofiltration membrane method) so as to arrive at a reduced chloride and/or—if present—fluoride content of at most 500 ppm, preferably of at most 400 ppm or 300 ppm or 200 ppm, more preferably of at most 100 ppm, and most preferably of at most 50 ppm, with ppm relative to silica (“SiO₂”).

Optionally, step (b) of the present process further comprises the step of (b2) subsequently to step (b1) bringing the gel into contact with an anionic exchanger, for example an anionic exchange resin, to obtain the purified gel. This may, for example, be done by bringing the anionic exchange resin and the gel into contact with each other, preferably under mixing, in a batch reactor. Alternatively, this may, for example, be done by passing the gel through an anionic exchange resin to obtain the purified gel.

It is preferred that the water used in steps (b1) and (b2), or depending upon the method used, generally in step (b) is de-ionized water.

Though generally possible, it is preferred that following any one of steps (a) and (b) the silicic acid is not dried.

Subsequently to step (b), the present process comprises step (c) of adjusting the pH of the purified gel preferably to at least 9, more preferably to at least 10, and most preferably to at least 11.

Preferably, in step (c) of the present process the pH is adjusted to at most 13, and more preferably to at most 12.

Preferably, in step (c) the pH of the gel is adjusted by adding a base to the purified gel. Such base may be any suitable base. It is, however, preferred that such base is selected from the group consisting of potassium hydroxide, sodium hydroxide, lithium hydroxide, cesium hydroxide, rubidium hydroxide, ammonia, organic amines, and any blend of any of these. Of these, potassium hydroxide and ammonia are particularly preferred.

Suitable organic amines may be selected from the group consisting of alkyl amines, alkanol amines, and any blend of these, with alkanol amines being preferred.

Examples of suitable alkyl amines may be represented by the following formula (2)

H_{3-b}NR¹_{b} (2)

wherein b is an integer at each occurrence independently selected from the group consisting of 1, 2, and 3; and R¹ is an alkyl group having 1, 2, or 3 carbon atoms. Preferred alkyl amines may be selected from the group consisting of methylamine (H₂NMe), dimethylamine (HNMe₂), trimethylamine (NMe₃), ethylamine (H₂NEt), diethylamine (HNEt₂), triethylamine (NEt₃), and any blend of any of these.

Examples of suitable alkanol amines may be represented by the following formula (3)

H₂N—R²—OH (3)

wherein R² is at each occurrence independently an alkanediyl having at least one and at most five carbon atoms. Thus, R² may at each occurrence independently be selected from the group consisting of methylene (—CH₂-), ethanediyl (—CH₂—CH₂-), propanediyl (—(CH₂-)₃), butanediyl (—(CH₂-)₄), and propanediyl (—(CH₂-)₅).

Preferred alkanol amines may be selected from the group consisting of 2-amino ethanol, 3-amino propanol, and 4-amino butanol, with 2-amino ethanol being most preferred.

Depending on the type of base added, the present method advantageously allows to produce silica particles characterized by low trace metal content or low organic residue content or both. For example, selecting a base different from potassium hydroxide allows for production of silica particles with low potassium content and/or low organic residue content and other trace metal contaminants present in the potassium hydroxide. An example of a base different from potassium hydroxide that may be preferably selected is ammonia. Thus, the choice of base in step (c) may be made depending upon the requirements of the application targeted. Blends of the bases may also be preferred depending on the requirements of the application and to achieve the desired effect while minimizing trace metal contamination typically present in the different bases.

Following step (c), the now purified silicic acid is polycondensated to form the silica particles. Such polycondensation may be represented by the following generalized reaction scheme (I)

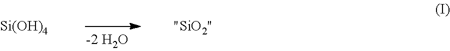

Optionally, in step (d) so-called seed particles may be introduced, onto which then silicic acid is polycondensated to form the silica particles. Alternatively, the formation of the silica particles may be started “in situ”, i.e. directly from the purified silicic acid without introducing seed particles.

Shape and dimensions of the silica particles produced according to the present process are not particularly limited provided that such silica particles are suitable for the intended application. They may, if spherical, have an average diameter of at least 2 nm and of at most 200 nm. Such silica particles may, for example, be spherical, oval, curved, bent, elongated, branched, or cocoon-shaped. Elongated or oval silica particles may have an aspect ratio of at least 1.1. Shape and dimension of the silica particles may depend upon the intended application and may also include silica particles of different dimension and/or size.

For spherical silica particles, the average diameter is preferably at least 5 nm, more preferably at least 10 nm, and most preferably at least 15 nm. For spherical particles, the average diameter is preferably at most 200 nm, more preferably at most 150 nm or 100 nm, even more preferably at most 90 nm or 80 nm or 70 nm or 60 nm, still even more preferably at most 50 nm or 45 nm or 40 nm or 35 nm or 30 nm, and most preferably at most 25 nm. For example, particularly preferred silica particles have an average diameter of at least 15 nm and of at most 25 nm.

For elongated, curved, bent, branched, and oval silica particles their average diameter is preferably as described above for spherical colloidal silica particles. Preferably, such elongated or oval colloidal silica particles have an aspect ratio, i.e. the ratio of length to average diameter, of at least 1.1, more preferably of at least 1.2 or 1.3 or 1.4 or 1,5, even more preferably at least 1.6 or 1.7 or 1.8 or 1.9, and most preferably at least 2.0. Said aspect ratio is preferably at most 10, more preferably at most 9 or 8 or 7 or 6, and most preferably at most 5.

The silica particles produced in accordance with the present method may be comprised in a composition, the composition further comprising water. Thus, such composition comprises the present silica particles and water. Preferably the water is de-ionized water.

Such composition may be provided as a concentrate, which may then be diluted with water, preferable de-ionized water, prior to its use in the intended application. Such concentrate may comprise the present silica particles in up to 20 wt %, preferably in up to 25 wt %, more preferably in up to 30 wt %, even more preferably in up to 35 wt %, still even more preferably in up to 40 wt % and most preferably in up to 50 wt %, with wt % relative to the total weight of the present composition or concentrate.

Alternatively, at the point of use, for example when used in a chemical mechanical polishing process, the present composition preferably comprises the modified silica particles in at least 0.1 wt % (for example in at least 0.2 wt % or 0.3 wt % or 0.4 wt %), more preferably in at least 0.5 wt %, even more preferably in at least 1.0 wt, still even more preferably in at least 1.5 wt %, and most preferably in at least 2.0 wt %, with wt % relative to the total weight of the present composition. In this case, the present composition preferably comprises the present silica particles in at most 40 wt %, more preferably in at most 30 wt %, even more preferably in at most 20 wt %, still even more preferably in at most 15 wt %, and most preferably in at most 10 wt %, with wt % relative to the total weight of the present composition. The at-the-point-of-use concentration or amount of silica particles in the present composition may depend on the intended application as well as performance requirement. The at-the-point-of-use concentration or amount of silica particles in the present composition may easily be modified by diluting the present composition or concentrate, preferably with de-ionized water.

Optionally, the present composition further comprises any one or more of the group consisting of biocide, pH-adjusting agent, pH-buffering agent, oxidizing agent, chelating agent, corrosion inhibitor, surfactant, and any other additive that may be required for achieving or modifying performance as required by the intended application.

Such oxidizing agent may be any suitable oxidizing agent for the one or more metal or metal alloy of the substrate to be polished using the present composition. For example, the oxidizing agent may be selected from the group consisting of bromates, bromites, chlorates, chlorites, hydrogen peroxide, hypochlorites, iodates, monoperoxy sulfate, monoperoxy sulfite, monoperoxy phosphate, monoperoxy hypophosphate, monoperoxy pyrophosphate, organo-halo-oxy compounds, periodates, permanganate, peroxyacetic acid, ferric nitrates, and any blend of any of these. Such oxidizing agent may be added to the present composition in a suitable amount, for example, in at least 0.1 wt % and at most 6.0 wt %, with wt % relative to the total weight of the present composition at point of use.

Such corrosion inhibitor, which may, for example, be a film forming agent, may be any suitable corrosion inhibitor. For example, the corrosion inhibitor may be glycine, which may be added in an amount of at least 0.001 wt % to 3.0 wt %, with wt % relative to the total weight of the present composition at point of use.

Such chelating agent may be any suitable chelating or complexing agent for increasing the removal rate of the respective materials, preferably metal or metal alloy, to be removed, or alternatively or in combination for capturing trace metal contaminants that may unfavorably influence performance in the polishing process or in the finished device. For example, the chelating agent may be compounds comprising one or more functional groups comprising oxygen (such as carbonyl groups, carboxyl groups, hydroxyl groups) or nitrogen (such as amine groups or nitrates). Examples of suitable chelating agents include, in a non-limiting way, acetylacetonates, acetates, aryl carboxylates, glycolates, lactates, gluconates, gallic acid, oxalates, phthalates, citrates, succinates, tartrates, malates, ethylenediaminetetraacetic acid and salts thereof, ethylene glycol, pyrogallol, phosphonates, ammonia, amino alcohols, di-and tri-amines, nitrates (e.g. ferric nitrates), and any blend of any of these.

Such biocide may be selected from any suitable biocide. As example of a suitable biocide, mention may be made of isothiazolin derivative-comprising biocides. Such biocide is generally added in an amount of at least 1 ppm and of at most 100 ppm of active compound, with ppm relative to the total weight of the present composition at point of use. The amount of biocide added may be adapted depending, for example, upon the composition and planned storage period.

Such pH-adjusting agent may be selected as appropriate and may be any suitable acid or base. Suitable acids may, for example, in a non-limiting way, be selected from the group consisting of hydrochloric acid, nitric acid or sulfuric acid, with nitric acid or sulfuric acid being preferred, and with nitric acid being particularly preferred. Suitable bases may, for example, be selected from the group consisting of alkali metal hydroxides, ammonia, organic amines as defined above, and any blend of any of these. For the alkali metal hydroxides, the alkali metal may be selected from the group consisting of Li, Na, K, and Cs, preferably from the group consisting of Li, Na, and K; and most preferably the alkali metal is K.

Such surfactant may be selected from any suitable surfactant, such as cationic, anionic and non-ionic surfactants. A particularly preferred example is an ethylenediamine polyoxyethylene surfactant. Generally, surfactants may be added in an amount of from 100 ppm to 1 wt %, with wt % relative to the total weight of the present composition at point of use.

Some of these compounds may exist in form of a salt, such as a metal salt, acid, or as a partial salt. Equally, some of these compounds may fulfill more than one function if comprised in a composition suitable for chemical mechanical polishing. For example, ferric nitrates, particularly Fe (NO₃)₃, may act as chelating agent and/or oxidizing agent and/or catalyst agent.

Such composition as defined herein may be prepared by standard methods, well known to the skilled person. Generally, such preparation involves mixing and stirring phases. It can be performed either in continuous manner or batchwise.

The silica particles produced by the present method as well as the compositions comprising such silica particles may be used in any application as silica produced via sodium or potassium silicate by a conventional wet production process. Thus, the silica particles produced by the present method may be used, for example, as abrasives, as additives in paper making and in the paper itself, as catalyst supports, as drug carriers, in coatings or paints, to only name a few.

Preferably, the present silica particles as well as the compositions comprising such silica particles may be used in the production of modern semiconductor devices, memory devices, integrated circuits and the likes, which comprise alternating layers of conductive layers, semiconductive layers, and dielectric (or insulating) layers, with the dielectric layers insulating the conductive layers from one another. Connections between conductive layers may be established, for example, by metal vias. In producing such devices conductive, semiconductive, and/or dielectric materials are consecutively deposited onto and in part again removed from the surface of a semiconductive wafer.

Chemical-mechanical polishing (CMP) is a widely used method for planarizing or removing part or all of a layer in the process of producing semiconductor devices and the likes. In the CMP process, an abrasive and/or corrosive chemical slurry, such as for example a slurry of silica particles, is used together with a polishing pad. Pad and substrate or surface, e.g. a wafer, are pressed together and generally rotated non-concentrically, i.e. with different rotational axes, thereby abrading and removing material from the surface or substrate.

CMP may be used to polish a wide range of materials, such as metals or metal alloys (such as, for example, aluminum, copper or tungsten), metal oxides, silicon dioxide, or even polymeric materials. For each material, the polishing slurry needs to be specifically formulated so as to optimize its performance. For example, if a tungsten layer that has been deposited onto a silicon dioxide layer is to be polished, the polishing slurry preferably has a high removal rate for tungsten but a lower one for silicon dioxide so as to efficiently remove the tungsten but leave the silicon dioxide layer largely intact.

Further, because the polishing preferably is done by a combination of mechanical polishing and chemical corrosion, the silica particles need to fulfill certain requirements so as to be fully compatible with the formulation. For example, the composition of the silica particles needs to be modified depending upon whether the particles are to be anionic or cationic.

The composition as described herein is may preferably be used in a chemical mechanical polishing (CMP) process, wherein a substrate is polished. The present method for chemical mechanical polishing therefore comprises the following steps of
(A) providing a substrate to be polished; and
(B) providing the composition as defined herein.

In the CMP-process a polishing pad with a polishing surface is used for the actual polishing of the substrate. Such polishing pad may, for example, be a woven or non-woven polishing pad, and comprise or essentially consist of a suitable polymer. Exemplary polymers include polyvinylchloride, polyvinylfluoride, nylon, poly-propylene, polyurethane, and any blend of these, to only name a few. Polishing pad and the to be polished substrate are generally mounted on a polishing apparatus, pressed together, and generally rotated non-concentrically, i.e. with different rotational axes, thereby abrading and removing material from the surface or substrate. Thus, the present CMP process further comprises the steps of
(C) providing a chemical mechanical polishing pad with a polishing surface;
(D) bringing the polishing surface of the chemical mechanical polishing pad into contact with the substrate; and
(E) polishing the substrate such that at least a part of the substrate is removed.

The present CMP process may be applied in the production of flat panel displays, integrated circuits (ICs), memory or rigid disks, metals, interlayer dielectric devices (ILDs), semiconductors, micro-electro-mechanical systems, ferroelectrics, and magnetic heads. In other words, the substrate to be polished in the present CMP process may be selected from the group consisting of flat panel displays, integrated circuits (ICs), memory or rigid disks, metals, interlayer dielectric devices (ILDs), semiconductors, micro-electro-mechanical systems, ferroelectrics, and magnetic heads.

The workings and advantages of the present application are to be illustrated with the following examples in a non-limiting exemplary way.

### EXAMPLES

All of the materials used in the following examples are commercially available. Silicon (IV) chloride in 99.0+% purity were obtained from SigmaAldrich, a subsidiary of Merck KGaA, Darmstadt, Germany, or in 99.8+% purity from Acros Organics, a brand of Thermo Fisher Scientific. Water was used as ultra-pure water, prepared with a Milli-Q® water purification system commercially available from Merck KGaA, Darmstadt, Germany.

Cation exchange resin used was AMBERJET™ 1200 H, supplied by Rohm and Haas Company, Philadelphia, Pennsylvania, USA.

### Example 1

800 ml of ultra-pure water at room temperature were provided in a 1.5 l round-bottom flask. Then 117.5 g of SiCl₄ were taken up into a 100 ml plastic syringe and from there introduced into the ultra-pure water under stirring over a period of about 5 min, resulting in a rise of temperature of the aqueous reaction mixture inside the flask to about 57° C. Subsequently the aqueous reaction mixture was allowed to settle for about 30 min without stirring, during which time a gel was formed. Afterwards the aqueous reaction mixture comprising the gel was filtered in a Buechner funnel using Whatman filter paper 0965 to yield 854 ml of filtrate.

The gel retained in the Buechner funnel was washed at room temperature with 800 ml of ultra-pure water, transferred to a beaker, and therein treated with 36 ml of potassium hydroxide solution (45.65 wt %) at 70° C. for 1.5 hours while stirring, yielding a potassium silicate solution (415 g theoretical yield) with 10 wt % SiO₂ (with wt % relative to the total weight of the potassium silicate solution) and a weight ratio of SiO₂ to K₂O of 2.23. The so-obtained potassium silicate solution was then passed through a column of cation exchange resin in order to prepare the solution of silicic acid.

### Example 2

The solution of silicic acid obtained in Example 1 above may then be used to prepare silica particles with a diameter of 9 nm. A stainless steel reactor having a volume of 2.8 l is first charged with ca. 450 ml of de-ionized water and then with 1155 g of aqueous silicic acid solution having a silica concentration of ca. 5.6 wt % (relative to the weight of the aqueous silicic acid solution) and a pH of 2.75. To this, ca. 29 g of aqueous potassium silicate solution containing ca. 5.8 g of silica and a weight ratio of SiO₂/K₂O=0.953 (obtained by the addition of KOH to the corresponding volume of the silicic acid solution obtained in Example 1 above, followed by concentration through evaporation to the desired volume) are added while stirring. The resulting reaction medium is heated to boiling and maintained boiling while adding at a rate of ca. 8 g/min a further 2240 g of the aqueous silicic acid solution having a silica concentration of ca.

5.6 wt % (relative to the weight of the aqueous silicic acid solution) and a pH of 2.75. Once the addition of the aqueous silicic acid solution is complete, heating may be continued for some time, for example for half an hour, and then turned off and the reaction medium allowed to cool. The resulting aqueous (colloidal) silica composition is expected to have a specific density of ca. 1.13 g/cm³, a surface area of ca. 300 m²/g for the silica, a pH of ca. 10.3, a silica content of ca. 19 wt % (relative to the total weight of the silica composition), and a viscosity of ca. 2 mPa·s.

### Example 3

The procedure of Example 2 was adapted to produce silica particles having a diameter of around 40 nm, with measured particle diameters as indicated in Table 1 below.

### Example 4—Polishing

Chemical mechanical polishing was performed with aqueous compositions of comparative silica particles (denoted S-4a) produced by a conventional “wet” process, i.e. commercially available silica particles produced not in accordance with the process of the present application, as well as silica particles (denoted S-4b and S-4c) produced as described above in Example 3 in accordance with the present application. Properties of the aqueous compositions were as indicated in Table 1, with wt % relative to the total weight of the respective aqueous composition. Before being used in polishing the aqueous compositions were filtered (0.3 μm).

TABLE 1

| | | S-4a | | |
|---|---|---|---|---|
| Reference | | (comparative) | S-4b | S-4c |
| Density at 20° C. | [kg l⁻¹] | 1.1978 | 1.1975 | 1.1971 |
| Silica content | [wt % SiO₂] | 30 | 30 | 30 |
| pH at 20° C. | | 2.5 | 2.6 | 3.1 |
| Particle diameter | [nm] | 40.1 | 42.5 | 40.8 |

Indicated particle diameters are the z-average particle sizes determined by Dynamic Light Scattering (DLS).

Chemical mechanical polishing was then performed on a Bruker CP-4 system (available from Bruker Corporation, Billerica, Massachusetts, USA), using an IC1000™M CMP polishing pad (available from DuPont de Nemours, Wilmington, Delaware, USA) on 4 inch TEOS (silicon oxide) wafers. Further polishing conditions were as indicated in the following Table 2.

TABLE 2

| Flow rate | 80 | ml min⁻¹ |
|---|---|---|
| Polishing time | 1 | min |
| Dynamic force | 5 psi as down force | |
| Platen speed (PS) | 115 | rpm |
| Head speed (HS) | 90 | rpm |

| | |
|---|---|
| Pad conditioner | A165-CIP1 (4.25″, 3M) |

Results for chemical mechanical polishing were as shown in Table 3 below, with PC-1 being the comparative example.

TABLE 3

| | PC-4a | | |
|---|---|---|---|
| Reference | (comparative) | PC-4b | PC-4c |
| Silica particle reference | S-4a | S-4b | S-4c |
| Removal rate [A min⁻¹] | 3016 | 3267 | 3701 |

Polishing performance of silica particles S-4b and S-4c produced in accordance with the method of the present application was even—despite expectations—improved, as evidenced by the significantly increased removal rates compared to silica particles produced not in accordance with the method of the present application but otherwise of similar physical properties.

In general, the present method for the production of silica particles offers the advantage of allowing to produce silica particles having a lower level of metal contaminants as silica particles having been produced by a conventional “wet” process, i.e. a process wherein sodium silicate is converted into orthosilicic acid using an ion exchange process. Furthermore, and this has come as a great surprise, the silica particles produced in accordance with the present process even have an improved polishing performance as compared to silica particles produced by the conventional “wet” process. The silica particles produced with the present method are therefore believed to be very well-suited for use in chemical mechanical polishing processes, for example, in the semiconductor industry.

1. Method for the production of silica particles, said method comprising the steps of
(a) hydrolyzing a silicon chloride in aqueous solution, thereby producing a gel comprising silicic acid and hydrogen chloride, wherein the silicon chloride is of the following formula (1′)
R_{c}Si(OH)_{d}Cl_{4-c-d} (1′)
with R being at each occurrence independently selected from the group consisting of alkyl groups having 1, 2, or 3 carbon atoms; and c being at each occurrence independently selected from the group consisting of 0, 1, 2, and 3; and d being at each occurrence independently selected from the group consisting of 0, 1, 2, and 3; provided that c+d≤3;
(b) removing at least part of the hydrogen chloride from the gel to obtain a purified gel;
(c) adjusting the pH of the purified gel to at least 9; and
(d) then polycondensating silicic acid to form the silica particles.

2. Method according to claim 1, wherein the silicon chloride is of the following formula (1)
RₐSiCl₄₋ₐ (1)
with R being at each occurrence independently selected from the group consisting of alkyl groups having 1, 2, or 3 carbon atoms; and a being an integer at each occurrence independently selected from the group consisting of 0, 1, 2, and 3;

3. Method according to claim 1, wherein R is at each occurrence independently selected from the group consisting of methyl, ethyl, n-propyl, and iso-propyl; preferably is methyl or ethyl; and most preferably is methyl.

4. Method according to claim 2, wherein a is 0 or 1, and preferably wherein a is 0.

5. Method according to claim 1, wherein the silicon chloride is independently selected from the group consisting of SiCl₄, MeSiCl₃, Me₂SiCl₂, Me₃SiCl, EtSiCl₃, Et₂SiCl₂, Et₃SiCl, and any blend of any of these; preferably from the group consisting of SiCl₄, MeSiCl₃, Me₂SiCl₂, Me₃SiCl, and any blend of any of these; more preferably is SiCl₄ or MeSiCl₃, and most preferably is SiCl₄.

6. Method according to claim 1, wherein step (a) is performed at a temperature of at least 0° C. and at most 120° C.

7. Method according to claim 1, wherein in step (b) the combined content in chloride or fluoride or both is reduced to at most 40,000 ppm, relative to silica (“SiO₂”).

8. Method according to claim 1, wherein step (b) comprises the following steps of
(b1) washing the gel by the addition and subsequent removal of water; and
(b2) preferably, subsequently to step (b1) passing the gel through an anionic exchange resin to obtain a purified gel.

9. Method according to claim 1, wherein following step (a) and/or step (b) the silicic acid is not dried.

10. Method according to claim 1, wherein in step (c) the pH of the gel is adjusted by adding a base to the purified gel, with the base preferably being selected from the group consisting of potassium hydroxide, sodium hydroxide, lithium hydroxide, cesium hydroxide, rubidium hydroxide, ammonia, organic amines, and any blend of any of these.

11. Method according to claim 1, wherein in step (c) the pH of the gel is adjusted to at least 10.

12. Method according to claim 1, wherein in step (c) the pH of the gel is adjusted to at most 13.

13. Method according to claim 1, wherein the silica particles formed in step (d) are colloidal silica particles.

14. Method according to claim 1, wherein step (d) also comprises introducing silica seeds, onto which silicic acid is polycondensated to form the silica particles.

15. Method according to claim 1, wherein the so-produced silica particles are used in chemical-mechanical polishing in the electronics industry, catalyst supports, prime wafer polishing etc.

16. Silica particles obtained by the method of claim 1.

17. Formulation comprising an aqueous dispersion of the silica particles of claim 16.
